(19) United States
(12) Patent Application Publication
(10) Pub. No.: US 2006/0022466 A1
(43) Pub. Date: Feb. 2, 2006

(54) Flange adapter

(76) Inventors: Kim Sand, Chalfont, PA (US); Preben Brock, Nordborg (DK)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/157,591

(22) Filed: Jun. 21, 2005

Related U.S. Application Data
(60) Provisional application No. 60/582,190, filed on Jun. 23, 2004.

(51) Int. Cl. F16L 23/00

(52) U.S. Cl. 285/412

(57) ABSTRACT

An apparatus for connecting a measuring device to a piping system such as fittings or pipe in which the measuring device allows for the flow and measurement of a mass. Each apparatus comprising two adapter flange bodies each having a circumferential groove mateable with the measuring device. The adapter flanges are compressed against each other by connecting bolts.

### CROSS-REFERENCE TO RELATED APPLICATIONS

This application claims priority to, and incorporates by reference in its entirety, provisional application, Ser. No. 60/582,190, filed Jun. 23, 2004.

### FIELD OF THE INVENTION

The present invention relates to an apparatus for inserting a measuring device in-line with a piping system. The apparatus having compressing flange bodies to join the measuring device to the piping system.

### BACKGROUND OF THE INVENTION

The invention relates to the use of an adapter to mate upstream and downstream pipes with an intra-pipe measuring device. More specifically, the invention relates to the use of flange adapters having a mateable circumferential groove with the outer surface of an in-line flowmeter.

There are currently several methods of inserting measuring devices in pipes with various attaching devices. Typical of the current methods of connecting flowmeters to pipes, is the placement of a flange on both ends of the metering device. These flowmeter flanges are then connected to flanges which are connected to the ends of both upstream and downstream pipes by welding or bonding. A disadvantage to this approach is the frequency of misaligned apertures between the connection flanges.

Another approach used to connect flowmeters to pipes is to have pipe extensions from the flowmeters clamped to the ends of the upstream and downstream piping. Clamping is achieved through various forms of clamping brackets applied to the pipe end of a connecting flange and to the connecting pipe.

However, both of these alternatives lack the ability to withstand high pressure flow and to align pipe and flowmeter apertures. Accordingly, there is a need for a method and apparatus for connecting in-line measuring devices with intake and outtake pipes.

The present invention solves these deficiencies by using a flange having a circumferential groove on the meter side of the flange which engages and seals the connection; tapered interior surface which minimizes flow turbulence; and connecting holes 110 which are equidistant from each other and are correspondingly connectable with connecting bolts and nuts.

### SUMMARY OF THE INVENTION

The invention is an apparatus for connecting the ends of an in-line measuring device to a piping system having two flange adapter bodies, each flange adapter body having a disk portion and a tubular portion, the disk portion having a plurality of substantially and radially equidistant holes between a tubular side and a device side of the disk portion, the disk portion having a circumferential groove on the device side of the disk portion so as to mate with an end of the measuring device, each flange adapter having a tubular portion on the tubular side of the disk portion, the tubular portion joinable to a pipe; and a plurality of corresponding bolts and nuts insertable within each hole so as to compress the flange adapters against each other.

### BRIEF DESCRIPTION OF THE DRAWINGS

A wide variety of potential embodiments will be more readily understood through the following detailed description, with reference to the accompanying drawings in which:

FIG. 1 is a cross-sectional view of the adapter flange;

FIG. 2 is an exploded view of the adapter flange in configuration with a flowmeter and upstream/downstream pipes; and

FIG. 3 is a flowmeter frontal view of the adapter flange.

### DETAILED DESCRIPTION OF THE INVENTION

The present invention relates to a flange adapter 100 for connecting pipes to in-line measuring devices. Although the flange adapter 100 may be used in any intra-pipe configuration, the embodiment of the present invention as discussed herein will make reference to a flangeless flowmeter as the measuring device.

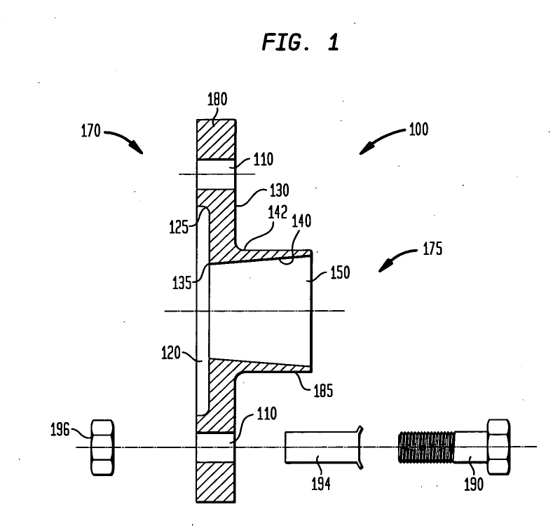

Shown in FIG. 1 is a cross-sectional view of the flange adapter 100. The flange adapter body 100 comprises generally of two sections, a tubular portion 185 and a disk portion 180, and may be constructed as one-integral piece or as a two piece device joined through various means such as welding or bonding. The flange adapter body 100 may be made of any material such as metal or plastic. Preferably the flange adapter body 100 is constructed of metal such as stainless steel when used for high pressure applications, although plastics have been know to withstand high pressure.

On the flowmeter side 170 (device side) of the adapter flange 100, the flange adapter 100 has a circumferential groove 120 mateable with the end outer circumference 155 of the flowmeter 240. The corner 125 of the circumferential groove 120 is radial or rounded so as to form a smooth transitional surface between the axial and transverse interior surfaces of the circumferential groove 120. A rounding of the edge is preferable so as to accommodate the placement of an insert such as a washer, ring or gasket (“gasket”). The gasket (not shown) is preferably flexible and constructed to substantially fit within the circumferential groove 120. Likewise the corner 135 between the circumferential groove 120 and the interior surface 140 is rounded so as to create a smooth transition and minimize turbulence associated with flow.

The interior surface 140 of tubular portion 185 is tapered from the pipe side 175 of the adapter flange 100 towards the circumferential groove 120. The tapering of the interior surface 140 of tubular portion 185, serves four functions: 1) provides a friction fit between the outer surface of a pipe and the interior surface 140; 2) minimizes flow turbulence; 3) minimizes any abrupt changes in pressure due changes in flow diameter; and 4) minimizes bacterial or other biological growth. Although other degrees of tapering may be used, it is preferable that the tapering of the interior surface 140 should be less than or equal to 17 degrees with respect to the interior surface 140 between the pipe end of the adapter flange and the circumferential groove.

Although it is preferable to have the pipe inserted within the interior surface 140 when using thin walled pipes, the adapter flange 120 may also be joined to a pipe by inserting the tubular portion185 within the interior surface of the connecting pipe. In either circumstance, welding or bonding of the tubular portionl85 to the pipe is preferable. In an alternate means of joining the tubular portion to either the upstream or downstream pipe, the tubular portion 185 may have threads on the interior surfacel40 or outer surface 142 of the tubular portion 185 so as to mateably engage with a pipe having egagable corresponding threads on either the interior or exterior surface of the pipe.

The disk portion 180 has a plurality of holes 110 through which connecting bolts are inserted. The bolts compress the two adapter flanges 100, when the bolts engage corresponding nuts in a threaded manner preferably at the pipe side 175 of the adapter flange 100.

The spacing of the holes 110 on disk portion 180 is substantially and radially equidistant from each other so as to maximize the application of compressive forces. Preferably, the holes 110 should also be positioned equidistantly from the circumference edge of the disk portion 180.

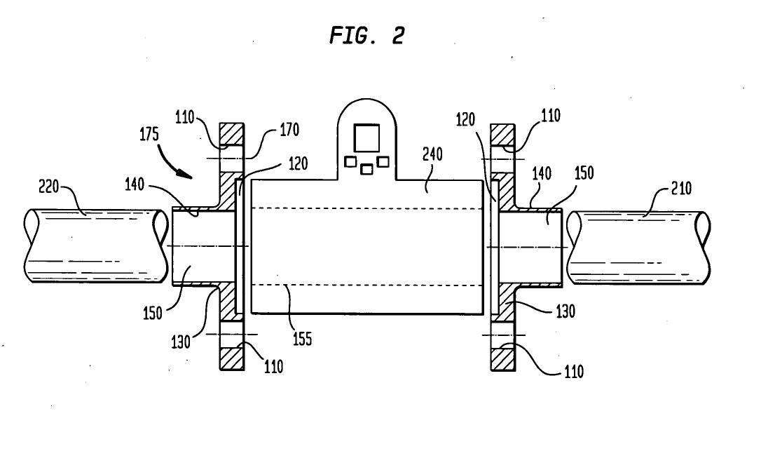

Shown in FIG. 2 is a flangeless flowmeter sandwiched between two adapter flanges 100. As shown, the ends of the flowmeter 155 mateably engage with the adapter flange 100 at the circumferential groove 120. Between the mating surfaces of the groove and the flowmeter, a gasket is placed to seal the contacting surfaces. In application, the two flange adapters 120 are compressed against each other and against the ends of the intermediate flowmeter 240.

Alignment of the flange adapters 120 and the flowmeter 240 is achieved through the mating of the respect ends of the flowmeter with corresponding circumferential grooves of each of the flange adapters 120. The result is the alignment of adapter orifices and the flowmeter orifice.

In addition, alignment of the two flange adapters 120 is also achieved by the insertion of bolts 190 between corresponding holes 110 between the two flange adapters 120. As shown in FIG. 1, a sleeve 194 is inserted through hole 110. A bolt is then inserted through sleeve 194. Both the sleeve 194 and bolt 190 are inserted through the two corresponding holes 110 on each of the adapter flanges 110. A nut 196 is then threaded and tightened on bolt 190. The nut and bolt are preferably made of non-corrosive materials such as plastics and steel. Gaskets may be used on either side of the bolt.

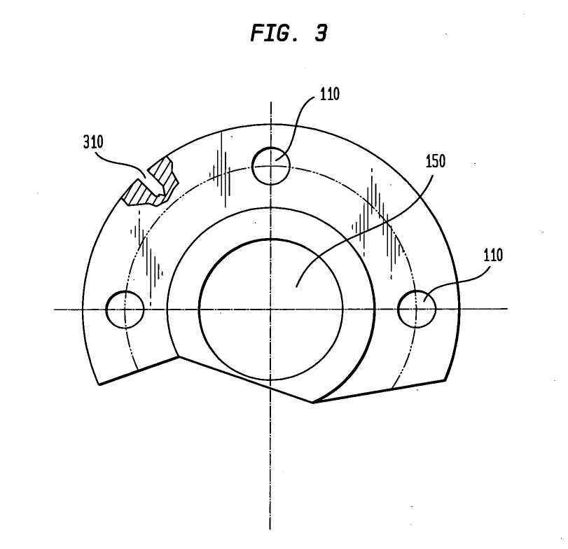

The sleeve 194 is preferably made of a rigid material such as hard plastic or metal such as stainless steel. The sleeves 194 serve to align the holes 110 on the disk portion 180 before the bolts are inserted. The rigidity of both the sleeve 194 and the bolt 190 serve to align the holes 110 and thereby aid the alignment of the flowmeter 240 within the circumferential grooves 120. It is preferable that the sleeve 194 engage holes 110 in corresponding adapter flanges 100 in a friction fit manner. Shown in FIG. 3 is a frontal side view of the adapter flange 120. Although a grounding hole 310 may be placed anywhere on the adapter flange 120, it is preferably placed on the circumferential or perimeter side of the disk portion 180. The hole 310 receives a screw type grounding plug engageable with the hole in a threaded manner. The plug is connected to a grounding wire which is connected to earth ground or a floating ground. A grounding plug on each of the flange adapters may be independently grounded or have one plug grounded and the other plug conductively connected to the grounded plug.

In an alternate embodiment of the invention, the perimeter of the circumferential groove 120 may be coated with a soft elastomer. By adding the soft elastomer coating, the coating provides primarily high abrasion resistance at the upstream connection with the flowmeter—although some abrasion resistance is also evident at the downstream connection. Moreover, the soft elastomer coating minimizes the risk of damaging the flowmeter during installation and enhances the seal between the flowmeter and the surface of the circumferential groove. In some low pressure applications the need for a gasket may be eliminated.

On the interior surface 140 of the tubular portion185, a hard elastomer coating or other protective coatings may be applied. The hard elastomer coating provides dimensional stability against the effects of pressure and water absorption so as to maintain measurement accuracy. Other protective coatings provide resistance to corrosion and/or abrasion. On the outside surface of the flange adapter 100, an epoxy coating may be applied.

The foregoing Detailed Description of a preferred embodiment should be understood as being in every respect illustrative and exemplary. The scope of the invention disclosed herein is not to be determined from the description of the invention, but rather from the Claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

What is claimed is:

1. An apparatus for connecting the ends of an in-line measuring device to upstream and downstream pipe, comprising:
two flange adapter bodies, each flange adapter body having a disk portion and a tubular portion, the disk portion having a plurality of substantially and radially equidistant holes between a tubular side and a device side of the disk portion, the disk portion having a circumferential groove on the device side of the disk portion so as to mate with an end of the measuring device, the tubular portion joinable to a pipe; and
means for compressing the two flange adapter bodies, such that each end of the measuring device mateably engages respective circumferential grooves on the device side of each of the disks.

2. The apparatus of claim 1, wherein the tubular portion and the disk portion are integral.

3. The apparatus of claim 1, wherein the tubular portion has an interior surface coated with a hard elastomer.

4. The apparatus of claim 3 wherein the interior surface is tapered from the tubular side to the device side.

5. The apparatus of claim 1, wherein the surface of the circumferential groove is coated with a soft elastomer.

6. The apparatus of claim 1, wherein the means for compressing the two flange adapters comprises a bolt and nut insertable within one of the plurality of holes.

7. The apparatus of claim 6, wherein the means for compressing the two flange adapters further comprises a sleeve insertable within one of the plurality of holes and the bolt is insertable within the sleeve.

8. The apparatus of claim 1, wherein the surface circumferential groove is radial between an axial and a transverse direction.

9. The apparatus of claim 1, further comprising a gasket on each of the circumferential grooves of the two flange adapters.

10. The apparatus of claim 1, further comprising a plug and wherein the disk portion has a mateable hole on the circumferential surface of the disk portion for mating with the plug.

11. The apparatus of claim 10, wherein a first plug is electrical grounded and a second plug is electrically connected to the first plug.

12. The apparatus of claim 10, wherein a first plug and a second plug on each of the two adapter flanges are independently grounded.

13. The apparatus of claim 1, wherein the tubular portion of each of the adapter flanges are threaded and joinable to a pipe.

14. The apparatus of claim 7, wherein the sleeve engages the hole in a friction fit.

15. The apparatus of claim 4, wherein the tapering of the interior surface is less than or equal to 17 degrees.

16. The apparatus of claim 1, wherein the surface of the circumferential groove has an axial surface and a transverse surface, the axial and transverse surfaces connecting at a radial corner.

17. An apparatus for connecting the ends of a flowmeter to upstream and downstream pipe, comprising:
two flange adapter bodies, each flange adapter body having a disk portion and a tubular portion, the disk portion having a tubular side and a flowmeter side and a circumferential groove on the flowmeter side of the disk portion so as to mate with an end of the flowmeter, the tubular portion joinable to a pipe; and means for compressing the two flange adapter bodies, such that each end of the measuring device mateably engages respective circumferential grooves on the device side of each of the disks.

18. An apparatus for connecting the ends of an in-line measuring device to upstream and downstream pipe, comprising:
two flange adapter bodies, each flange adapter body having a disk portion and a tubular portion, the disk portion having a plurality of substantially and radially equidistant holes between a tubular side and a device side of the disk portion, the disk portion having a circumferential groove having an axial surface and a transverse surface on the device side of the disk portion so as to mate with an end of the measuring device, the axial surface and transverse surface connecting at a radial corner, the tubular portion joinable to a pipe; and means for compressing the two flange adapter bodies, such that each end of the measuring device mateably engages respective circumferential grooves on the device side of each of the disks.

19. The apparatus of claim 18 wherein the tubular portion has an interior surface tapered from the tubular side to the device side.

20. The apparatus of claim 18, wherein the surface of the circumferential groove is coated with a soft elastomer.
